(19) United States
(12) Patent Application Publication
(10) Pub. No.: US 2021/0372065 A1
(43) Pub. Date: Dec. 2, 2021

(54) Tidal Flood Mitigation Assembly

(71) Applicant: Marcos Aleman, Miami Beach, FL (US)

(72) Inventor: Marcos Aleman, Miami Beach, FL (US)

(21) Appl. No.: 16/889,989

(22) Filed: Jun. 2, 2020

(51) Int. Cl. E02B 3/04

(52) U.S. Cl. CPC E02B 3/041

(57) ABSTRACT

A tidal flood mitigation assembly includes a riser that is attachable to a well head located in a coastal area. The riser extends at least 5.0 feet above ground to elevate the entry into the well head high enough to inhibit king tide flood waters from pouring outwardly from the well head. In this way the riser can mitigate king tide flood waters. A discharge pipe is fluidly coupled to the riser and the discharge pipe is in fluid communication with a sump pump. In this way the discharge pipe directs water from the sump pump into the well head. A breather tube is fluid coupled to the riser for purging air from the riser when the water level rises in the riser.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to flood mitigation devices and more particularly pertains to a new flood mitigation device for inhibiting king tide flood waters from flooding through a well head.

### (2) Description of Related Art Including Information Disclosed Under 37 CFR 1.97 and 1.98

The prior art relates to flood mitigation devices including a flood control pump that is positioned within a building to inhibit a sewer from backing up into the building. The prior art also discloses a buried fluid conduit that has lateral openings to facilitate flood water to drain into a leach field. The prior art also discloses a fluid pump that is fluidly coupled to a well head for moving surface level flood waters into a deep level aquifer. Additionally, the prior art discloses a pit-less water removal assembly for removing water adjacent to a foundation of a building.

### BRIEF SUMMARY OF THE INVENTION

An embodiment of the disclosure meets the needs presented above by generally comprising a riser is attachable to a well head located in a coastal area. The riser extends at least 5.0 feet above ground to elevate the entry into the well head high enough to inhibit king tide flood waters from pouring outwardly from the well head. In this way the riser can mitigate king tide flood waters. A discharge pipe is fluidly coupled to the riser and the discharge pipe is in fluid communication with a sump pump. In this way the discharge pipe directs water from the sump pump into the well head. A breather tube is fluid coupled to the riser for purging air from the riser when the water level rises in the riser.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a tidal flood mitigation assembly according to an embodiment of the disclosure.

FIG. 2 is a perspective in-use view of an embodiment of the disclosure.

### DETAILED DESCRIPTION OF THE INVENTION

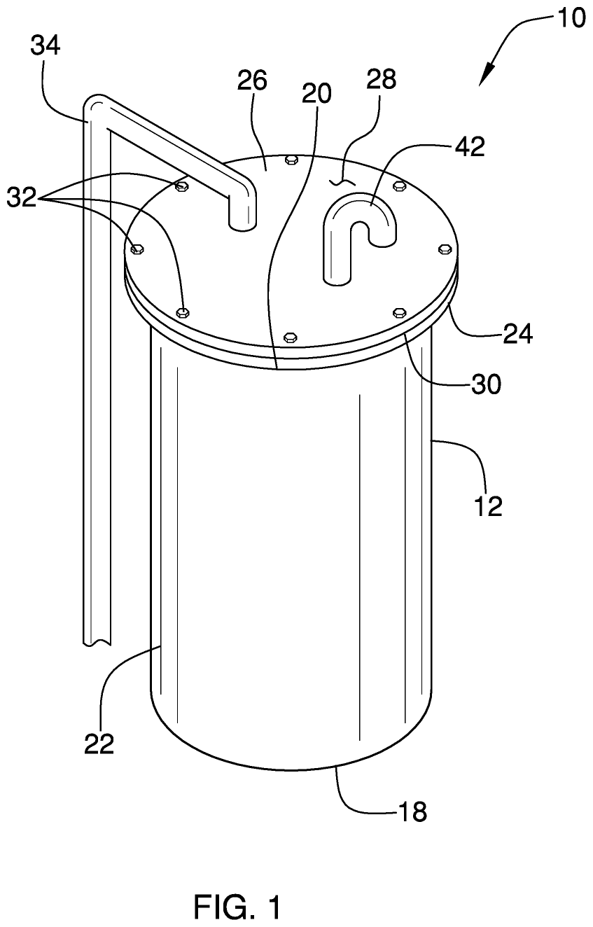

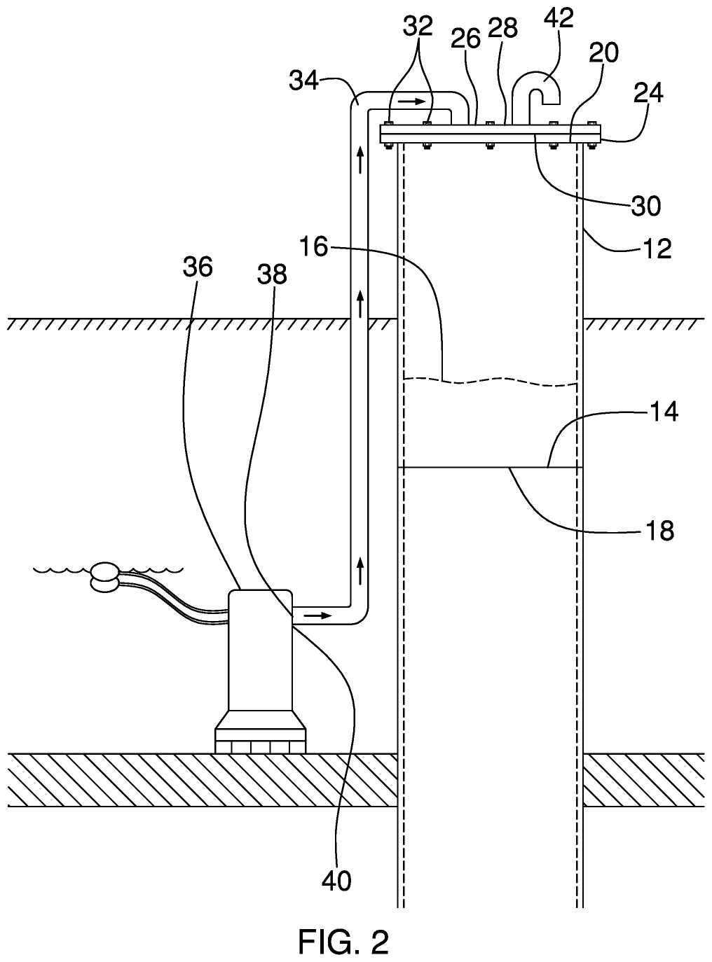

With reference now to the drawings, and in particular to FIGS. 1 through 2 thereof, a new flood mitigation device embodying the principles and concepts of an embodiment of the disclosure and generally designated by the reference numeral 10 will be described.

As best illustrated in FIGS. 1 through 2, the tidal flood mitigation assembly 10 generally comprises a riser 12 is attachable to a well head 14 located in a coastal area. The riser 12 extends at least 5.0 feet above ground to elevate the entry into the well head 14 high enough to inhibit king tide flood waters 16 from pouring outwardly from the well head 14. In this way the riser 12 helps to mitigate king tide flooding in low lying, coastal areas. Additionally, the well head 14 may be a well head for a municipal storm drainage system or other similar water handling system.

The riser 12 has a bottom end 18, a top end 20 and an outer wall 22 extending therebetween. The outer wall 22 has a ring 24 extending outwardly therefrom, and the ring 24 is oriented adjacent to and is coextensive with the top end 20. The bottom end 18 engages the well head 14 having the riser 12 extending along a vertical axis. In this way the top end 20 defines the entry into the well head 14.

A lid 26 is removably attached to the riser 12 for closing the riser 12. The lid 26 has a top surface 28 and a bottom surface 30, and the bottom surface 30 rests on the top end 20. A plurality of fasteners 32 is provided and each of the fasteners 32 extends through the lid 26 and engages the ring 24 for attaching the lid 26 to the riser 12. A discharge pipe 34 is provided that is fluidly coupled to the riser 12. The discharge pipe 34 is in fluid communication with a sump pump 36 to direct water from the sump pump 36 into the well head 14. The sump pump 36 may be a submersible sump pump that is located in a low lying area that is prone to flooding.

The discharge pipe 34 extends through the top surface 28 and the bottom surface 30 of the lid 26 such that the discharge pipe 34 is in fluid communication with an interior of the riser 12. The discharge pipe 34 has a distal end 38 with respect to the riser 12 and the distal end 38 is fluidly coupled to an outlet 40 of the sump pump 36. A breather tube 42 is fluid coupled to the riser 12 for purging air from the riser 12 when the water level rises in the riser 12. The breather tube 42 extends through the top surface 28 and the bottom surface 30 of the lid 26 such that the breather tube 42 is in fluid communication with the interior of the riser 12. In this way the breather tube 42 passes air outwardly therefrom when the discharge pipe 34 passes water into the riser 12. Additionally, the breather tube 42 curves downwardly to inhibit precipitation from entering the breather tube 42. Each of the discharge pipe 34 and the breather tube 42 may have a diameter of at least 3.0 inches, and the riser may have a diameter of at least 24.0 inches.

In use, riser 12 is attached to the well head 14 in order to elevate the entry of the well head 14 to a point that king tide flood waters 16 do not escape the well head 14 and subsequently flood the low lying area. In this way the riser 12 can mitigate flooding of residential streets and other areas that are commonly flooded by storm drain overflow. Additionally, the discharge pipe 34 facilitates any sump pumps that are positioned proximate the riser 12 to feed water into the riser 12. In this way any flood waters in the low lying area can be fed into the well head 14 for draining into the municipal storm drainage system.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A tidal flood mitigation assembly for mitigating floods caused by king tides or high tides, said assembly comprising:
a riser being attachable to a well head located in a coastal area, the well head draining into a municipal storm drainage system, said riser extending at least 5.0 feet to elevate an entry into the well head to inhibit king tide flood waters from pouring outwardly from the well head wherein said riser is configured to mitigate king tide flood waters;
a discharge pipe being fluidly coupled to said riser, said discharge pipe being in fluid communication with a sump pump configured to be positioned in a low lying area prone to flooding wherein said discharge pipe is configured to direct water from the sump pump into the well head; and
a breather tube being fluid coupled to said riser for purging air from said riser when the water level raises in said riser.

2. The assembly according to claim 1, wherein said riser has a bottom end, a top end and an outer wall extending therebetween, said outer wall having a ring extending outwardly therefrom, said ring being oriented adjacent to and being coextensive with said top end, said bottom end engaging the well head having said riser extending along a vertical axis wherein said top end defines the entry into the well head.

3. The assembly according to claim 2, further comprising:
a lid being removably attached to the riser for closing said riser, said lid having a top surface and a bottom surface, said bottom surface resting on said top end; and
a plurality of fasteners, each of said fasteners extending through said lid and engaging said ring for attaching said lid to said riser.

4. The assembly according to claim 3, wherein said discharge pipe extends through said top surface and said bottom surface of said lid such that said discharge pipe is in fluid communication with an interior of said riser, said discharge pipe having a distal end with respect to said riser, said distal end being fluidly coupled to an outlet of the sump pump.

5. The assembly according to claim 3, wherein said breather tube extends through said top surface and said bottom surface of said lid such that said breather tube is fluid communication with said interior of said riser, said breather tube passing air outwardly therefrom when said discharge tube passes water into said riser.

6. A tidal flood mitigation assembly for mitigating floods caused by king tides or high tides, said assembly comprising:
a riser being attachable to a well head located in a coastal area, the well head draining into a municipal storm drainage system, said riser extending at least 5.0 feet to elevate an entry into the well head high enough to inhibit king tide flood waters from pouring outwardly from the well head wherein said riser is configured to mitigate king tide flood waters, said riser having a bottom end, a top end and an outer wall extending therebetween, said outer wall having a ring extending outwardly therefrom, said ring being oriented adjacent to and being coextensive with said top end, said bottom end engaging the well head having said riser extending along a vertical axis Wherein said top end defines the entry into the well head;
a lid being removably attached to the riser for closing said riser, said lid having a top surface and a bottom surface, said bottom surface resting on said top end;
a plurality of fasteners, each of said fasteners extending through said lid and engaging said ring for attaching said lid to said riser;
a discharge pipe being fluidly coupled to said riser, said discharge pipe being in fluid communication with a sump pump configured to be positioned in a low lying area prone to flooding wherein said discharge pipe is configured to direct water from the sump pump into the well head, said discharge pipe extending through said top surface and said bottom surface of said lid such that said discharge pipe is in fluid communication with an interior of said riser, said discharge pipe having a distal end with respect to said riser, said distal end being fluidly coupled to an outlet of the sump pump; and
a breather tube being fluid coupled to said riser for purging air from said riser when the water level raises in said riser, said breather tube extending through said top surface and said bottom surface of said lid such that said breather tube is in fluid communication with said interior of said riser, said breather tube passing air outwardly therefrom when said discharge tube passes water into said riser.
